(19) United States
(12) Patent Application Publication
(10) Pub. No.: US 2018/0224628 A1
(43) Pub. Date: Aug. 9, 2018

(54) OPTICAL SYSTEM

(71) Applicant: TDK TAIWAN CORP., Yangmei Taoyuan (TW)

(72) Inventors: Chao-Chang HU, Yangmei Taoyuan (TW); Shu-Shan CHEN, Yangmei Taoyuan (TW)

(21) Appl. No.: 15/887,724

(22) Filed: Feb. 2, 2018

Related U.S. Application Data
(60) Provisional application No. 62/456,261, filed on Feb. 8, 2017.

(30) Foreign Application Priority Data
Jan. 8, 2018 (CN) 201810016049.4

(51) Int. Cl. G02B 7/10; G02B 27/64; G02B 7/09; G01D 5/20

(52) U.S. Cl. CPC G02B 7/102; G01D 5/20; G02B 7/09; G02B 27/646

(57) ABSTRACT

The disclosure provides an optical system, including a fixed part, a movable part, a driving assembly and a sensing coil. The fixed part includes a base. The movable part includes an optical element holder for holding an optical element. The driving assembly includes at least one first magnetic element and at least one second magnetic element. The second magnetic element corresponds to the first magnetic element and is configured to drive the optical element holder to move relative to the base. The sensing coil is configured to sense magnetic field variations in the first magnetic element, so as to obtain the distance between the optical element holder and the base.

### CROSS REFERENCE TO RELATED APPLICATIONS

This application claims the benefit of U.S. Provisional Application No. 62/456,261, filed Feb. 8, 2017, and claims priority of China Patent Application No. 201810016049.4, filed on Jan. 8, 2018, the entirety of which are incorporated by reference herein.

### BACKGROUND OF THE DISCLOSURE

### Field of the Disclosure

The present disclosure relates to an optical system, and more particularly to an optical system that does not include a position-sensing element.

### Description of the Related Art

As technology has progressed, many kinds of electronic devices such as smart phones have begun to include the functionality of digital photography or video recording. A user can operate the electronic device to capture various images using the camera module of the electronic device.

In general, the camera module includes a position sensor, a control unit and a lens driving unit, and the lens driving unit can be configured to drive a lens to move along an optical axis of the lens. When the camera module is shaken, the position sensor can sense the displacement of the lens, and the control unit can control the lens driving unit to drive the lens to move in the opposite direction according to the displacement, so as to achieve the purpose of optical image stabilization. However, the position sensor occupies interior space inside the camera module. Therefore, when the thickness of the electronic device needs to be reduced for the purpose of miniaturization, the thickness of the camera module cannot be reduced any further due to the size of the position sensor.

Therefore, how to prevent the position sensor from occupying too much space inside the camera module, and how to reduce the thickness of the camera module are topics nowadays that need to be discussed and solved.

### BRIEF SUMMARY OF THE DISCLOSURE

Accordingly, one objective of the present disclosure is to provide an optical system, so as to solve the above problems.

According to some embodiments of the disclosure, the optical system includes a fixed part, a movable part, a driving assembly and a sensing coil. The fixed part includes a base. The movable part includes an optical element holder configured to hold an optical element. The driving assembly includes at least one first magnetic element and at least one second magnetic element. The second magnetic element corresponds to the first magnetic element and is configured to drive the optical element holder to move relative to the base. The sensing coil is configured to sense a magnetic field variation in the first magnetic element, so as to obtain a distance between the optical element holder and the base.

In some embodiments, the first magnetic element comprises a coil, and a winding axis of the coil is substantially parallel to a winding axis of the sensing coil.

In some embodiments, the movable part further includes a frame, the first magnetic element is disposed on the frame, and the first magnetic element includes a coil.

In some embodiments, the optical system further includes a first resilient element, electrically connected to the sensing coil.

In some embodiments, the movable part further includes a frame, the first magnetic element is disposed on the optical element holder, and the sensing coil is disposed on the frame.

In some embodiments, the optical system further includes a first resilient element, a circuit board and two second resilient elements. The first resilient element is connected to the optical element holder and the frame. The two second resilient elements are connected to the first resilient element and the circuit board. The sensing coil is electrically connected to the circuit board through the two second resilient elements.

In some embodiments, the optical system further includes two second resilient elements, connected to the first resilient element and the circuit board. The driving assembly is electrically connected to the circuit board through the two second resilient elements.

In some embodiments, the first magnetic element is disposed on the optical element holder, and the sensing coil is disposed on the fixed part.

In some embodiments, the optical system further includes a circuit board disposed on the base, and the sensing coil is disposed on the circuit board and is electrically connected to the circuit board. The circuit board is located between the sensing coil and the base.

In some embodiments, the optical system further includes a circuit board disposed on the base, and the sensing coil is electrically connected to the circuit board.

In some embodiments, the sensing coil is disposed on a bottom surface of the circuit board, and the sensing coil is electrically connected to the circuit board through a solder point.

In some embodiments, the sensing coil and the first magnetic element are disposed on the optical element holder, and a winding axis of the first magnetic element is substantially parallel to a winding axis of the sensing coil.

In some embodiments, the sensing coil partially overlaps the first magnetic element when viewed along an optical axis of the optical element.

In some embodiments, the magnetic pole direction of the second magnetic element is substantially parallel to an optical axis of the optical element.

In some embodiments, the magnetic pole direction of the second magnetic element is substantially perpendicular to an optical axis of the optical element.

In some embodiments, the optical system includes two second magnetic elements, and a width of the sensing coil is less than a maximum distance between the N-poles of the two second magnetic elements.

In some embodiments, the fixed part further includes a casing, and the sensing coil is connected to the casing.

In some embodiments, a winding axis of the sensing coil is not parallel to an optical axis of the optical element.

In some embodiments, the driving assembly further includes a magnetic conductive element which is disposed near the second magnetic element.

In some embodiments, the optical system includes four second magnetic elements, the optical element holder has an octagonal structure, and each of the second magnetic elements has a trapezoidal structure, wherein the second magnetic elements are respectively disposed on four corners of the optical element holder.

In conclusion, the present disclosure provides an optical system which adopts a sensing coil configured to sense the movement of the optical element holder relative to the base. Because there is no position-sensing element or corresponding sensing magnet occupying the interior space inside the optical system, the overall size of the optical system can be reduced to achieve the purpose of miniaturization, and the magnetic interference that is a result of a position-sensing element and the corresponding sensing magnet can also be prevented.

In addition, there is no position-sensing element disposed in the optical system, so the optical system does not need to provide additional conductive lines for the position-sensing element. The sensing coil and the first magnetic element of the present disclosure can be electrically connected to the circuit board through the second resilient elements. Therefore, the complexity of the layout of conductive lines of the optical system can be reduced, the manufacturing cost can be reduced, and the size of the optical system can also be reduced, so as to achieve the purpose of miniaturization.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows a schematic diagram of an optical system according to an embodiment of the present disclosure.

FIG. 2 is an exploded diagram of the optical system in FIG. 2 according to the embodiment of the present disclosure.

FIG. 3 is a cross-sectional view along line A-A′ in FIG. 1 according to the embodiment of the present disclosure.

FIG. 4 shows a schematic diagram of the optical system after removing the casing according to the embodiment of the disclosure.

FIG. 5 shows a schematic diagram of an optical system according to another embodiment of the disclosure.

FIG. 6 shows a cross-sectional view of the optical system along line B-B′ in FIG. 5 according to the embodiment of the disclosure.

FIG. 7A shows a diagram of the sensing coil and the second magnetic elements in FIG. 6 according to the embodiment of the disclosure.

FIG. 7B shows a diagram of the sensing coil and the second magnetic elements according to another embodiment of the disclosure.

FIG. 8 shows a schematic diagram of an optical system according to another embodiment of the disclosure.

FIG. 9 shows a schematic diagram of an optical system according to another embodiment of the disclosure.

FIG. 10 shows a cross-sectional view of the optical system along line C-C′ in FIG. 9 according to the embodiment of the disclosure.

FIG. 11 shows a diagram illustrating the base, the circuit board and the sensing coil of the optical system in FIG. 9 when viewed in another view of angle.

FIG. 12 shows a cross-sectional view of an optical system according to another embodiment of the disclosure.

FIG. 13 shows a partial structure of the optical system according to the embodiment of the disclosure.

FIG. 14 shows a camera system according to another embodiment of the disclosure.

FIG. 15 shows a camera system according to another embodiment of the disclosure.

FIG. 16 shows a front view of the camera system in FIG. 15 according to the embodiment of the disclosure.

### DETAILED DESCRIPTION OF THE ILLUSTRATIVE EMBODIMENTS

In the following detailed description, for the purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. The directional terms, such as “up”, “down”, “left”, “right”, “front” or “rear”, are reference directions for accompanying drawings. Therefore, using the directional terms is for description instead of limiting the disclosure.

In this specification, relative expressions are used. For example, “lower”, “bottom”, “higher” or “top” are used to describe the position of one element relative to another. It should be appreciated that if a device is flipped upside down, an element at a “lower” side will become an element at a “higher” side.

The terms “about” and “substantially” typically mean +/−20% of the stated value, more typically +/−10% of the stated value and even more typically +/−5% of the stated value. The stated value of the present disclosure is an approximate value. When there is no specific description, the stated value includes the meaning of “about” or “substantially”.

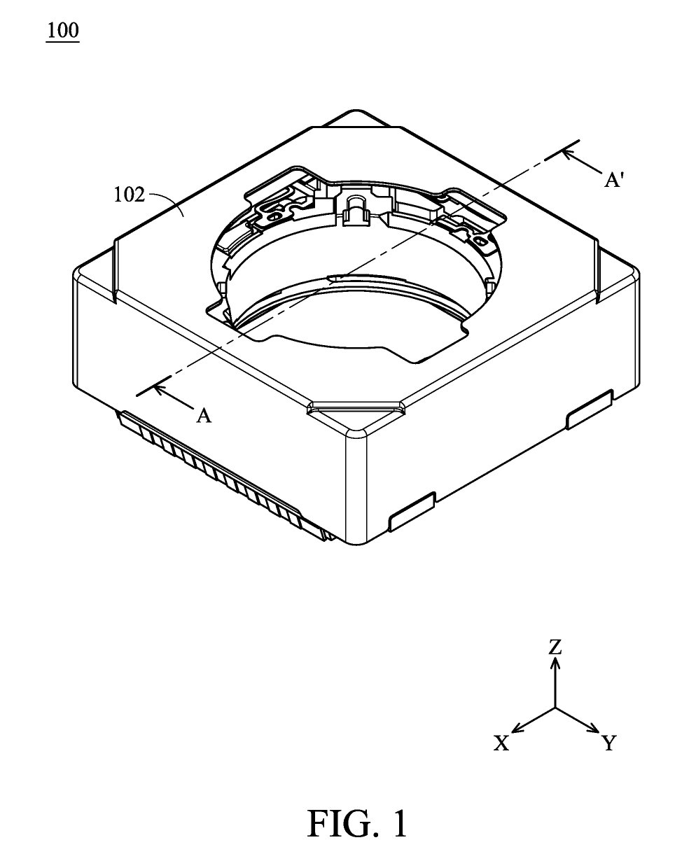

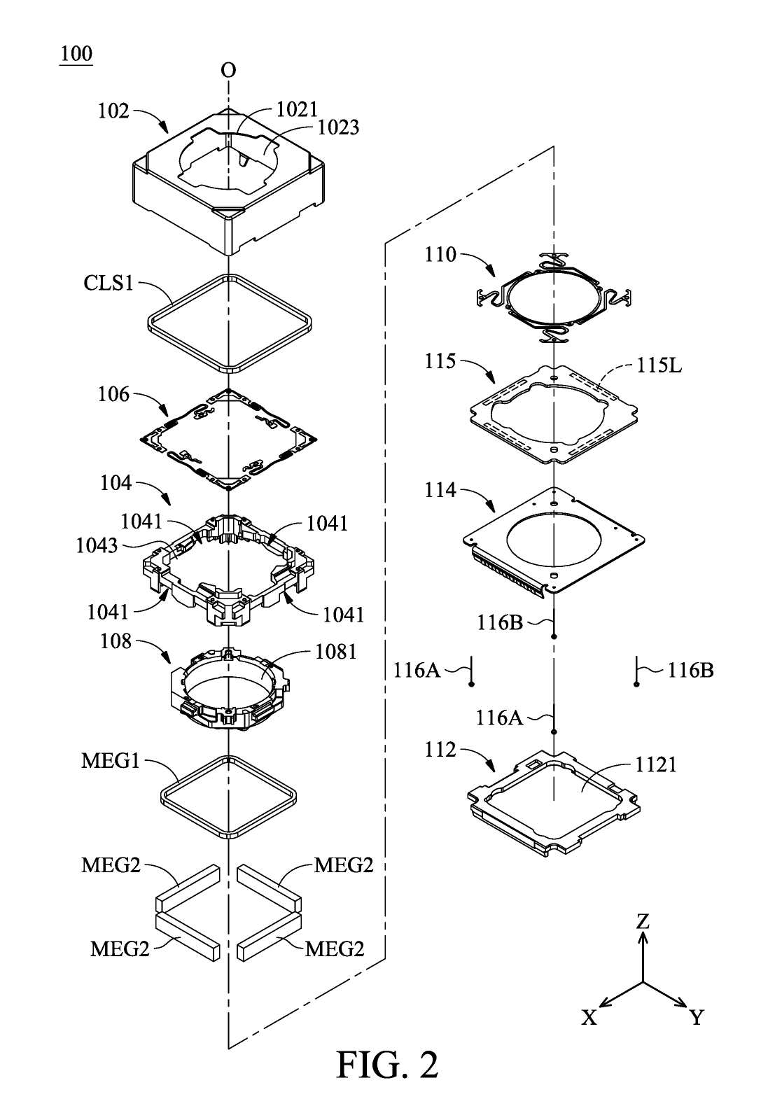

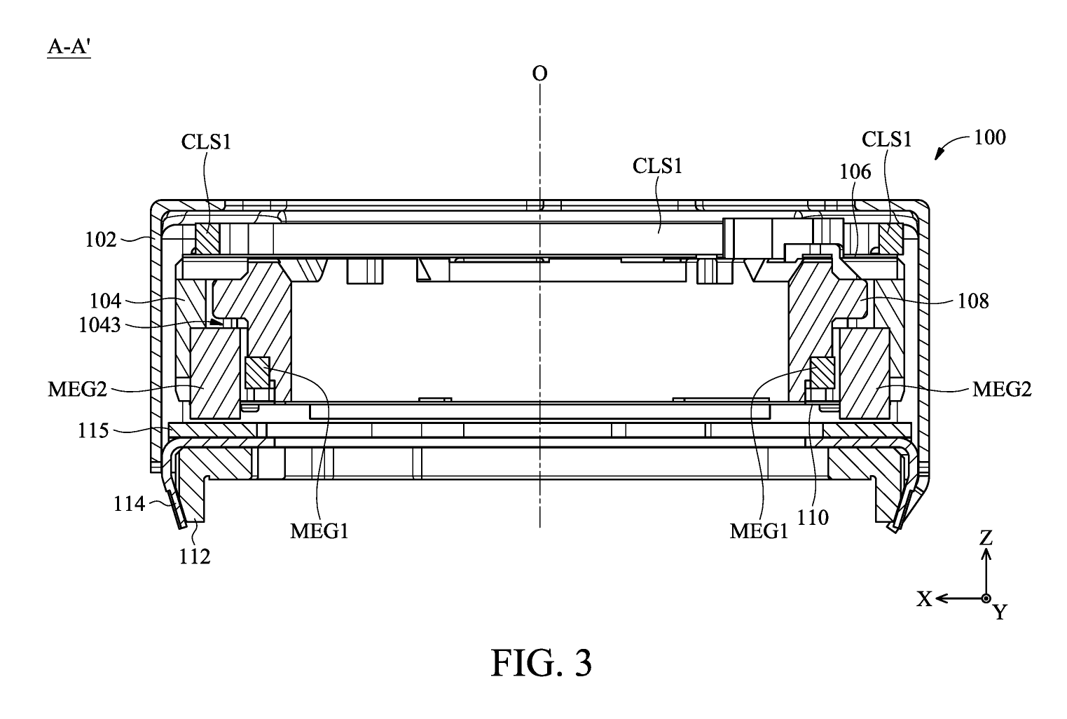

Please refer to FIG. 1 to FIG. 3. FIG. 1 shows a schematic diagram of an optical system 100 according to an embodiment of the present disclosure, FIG. 2 is an exploded diagram of the optical system 100 in FIG. 2 according to the embodiment of the present disclosure. FIG. 3 is a cross-sectional view along line A-A′ in FIG. 1 according to the embodiment of the present disclosure. The optical system 100 can be a camera system with an optical driving assembly and can be configured to hold an optical element (not shown in the figures), and the optical system 100 can be installed in different electronic devices or portable electronic devices, such as a smartphone or a tablet computer, for allowing a user to perform the image capturing function. In this embodiment, the optical driving assembly can be a voice coil motor (VCM) with an auto-focusing (AF) function, but it is not limited thereto. In some embodiments, the optical driving assembly of the optical system 100 can also perform the functions of auto-focusing and optical image stabilization (OIS).

Please refer to FIG. 2, which show an exploded diagram of the optical system 100 according to the embodiment of the disclosure. In this embodiment, the optical system 100 includes a casing 102, a frame 104, an upper spring sheet 106, an optical element holder 108, a first magnetic element MEG1, a sensing coil CLS1, four second magnetic elements MEG2, a low spring sheet 110, a base 112, a circuit board 114 and a plate coil 115 (a circuit board). The base 112 is securely connected to the casing 102, to be defined as a fixed part. The base 112 can be riveted to, engaged with, or welded with the casing 102, but the manner of connecting the base 112 with the casing 102 is not limited this embodiment. Any manner capable of securely connecting the base 112 with the casing 102 is within the scope of the disclosure. The fixed part can include other elements or members in other embodiments. In addition, the optical element holder 108 and the frame 104 can be defined as a movable part and can move relative to the fixed part.

The casing 102 has a hollow structure, and a casing opening 1021 is formed on the casing 102. A base opening 1121 is formed on the base 112. The center of the casing opening 1021 corresponds to an optical axis O of an optical element (not shown in the figures) which is held by the optical element holder 108. The base opening 1121 corresponds to an image sensing element (now shown in the figures) disposed below the base 112. The casing 102 can include an accommodating space 1023 for accommodating the frame 104, the upper spring sheet 106, the optical element holder 108, the first magnetic element MEG1, the sensing coil CLS1, the second magnetic elements MEG2 and the low spring sheet 110. Furthermore, the casing 102 can also accommodate the circuit board 114, the plate coil 115 and the base 112. In addition, the first magnetic element MEG1 can be a coil. The first magnetic element MEG1 and the second magnetic elements MEG2 corresponding to the first magnetic element MEG1 can be defined as a driving assembly, which is electrically connected to the circuit board 114 and is configured to drive the optical element holder 108 to move along the optical axis O relative to the base 112. It should be noted that the optical system 100 does not include any position-sensing element therein.

As shown in FIG. 2, the optical element holder 108 has a hollow ring structure, and the optical element holder 108 has a through hole 1081. The through hole 1081 forms a threaded structure (not shown) corresponding to another threaded structure (not shown) on the optical element, such that the optical element can be locked in the through hole 1081. In this embodiment, the first magnetic element MEG1 surrounds the optical element holder 108. In addition, the frame 104 has a plurality of grooves 1041 and a central opening 1043. In this embodiment, the frame 104 has four grooves 1041 for accommodating the second magnetic elements MEG2, but the amounts of the grooves 1041 and the second magnetic elements MEG2 are not limited thereto. In this embodiment, each of the second magnetic elements MEG2 has a long strip-shaped structure, but it is not limited thereto. For example, the second magnetic elements MEG2 can have different shapes in other embodiments.

The optical element holder 108 and the optical element are disposed in the central opening 1043 and can move relative to the frame 104. More specifically, as shown in FIG. 3, the optical element holder 108 is connected to the frame 104 through the upper spring sheet 106 and the low spring sheet 110, so as to be suspended in the central opening 1043. When the first magnetic element MEG1 is supplied with electricity, the four second magnetic elements MEG2 act with the first magnetic element MEG1 to generate the electromagnetic force, so as to drive the optical element holder 108 to move along the optical axis O (Z-axis direction) relative to the frame 104 and the base 112, so as to perform the auto focusing function. In some embodiments, the second magnetic elements MEG2 can include at least one multipolar magnet, configured to act with the corresponding first magnetic element MEG1 to drive the optical element holder 108 to move along the optical axis O, so as to perform the focusing function.

It should be noted that the upper spring sheet 106 or the low spring sheet 110 can be a first resilient element. In this embodiment, the upper spring sheet 106 can consist of four detachable spring sheets, and the low spring sheet 110 is integrally formed in one piece, but they are not limited thereto. For example, the upper spring sheet 106 can also be integrally formed in one piece in other embodiments.

As shown in FIG. 2 and FIG. 3, the sensing coil CLS1 is disposed on the top of the frame 104, and the winding axis of the sensing coil CLS1 is substantially parallel to the winding axis of the first magnetic element MEG1 (coil), and is parallel to the optical axis O. It should be noted that when the first magnetic element MEG1 is supplied with electricity to act with the four second magnetic elements MEG2 to generate the electromagnetic force to drive the optical element holder 108 to move along the optical axis O (Z-axis direction) relative to the frame 104, a distance between the sensing coil CLS1 and the first magnetic element MEG1 along the Z-axis direction also changes. Therefore, the sensing coil CLS1 can sense a magnetic field variation in the first magnetic element MEG1 and generates a sensing current to a processing unit (such as a micro-processor) of said portable electronic device. Then, the processing unit can determine the position of the optical element holder 108 relative to the base 112 according to the received sensing current and reference information. In this embodiment, the reference information can include a relationship table between the sensing current and the position of the sensing coil CLS1 relative to the first magnetic element MEG1. Because the distance between the sensing coil CLS1 and the base 112 is constant, when the distance between the sensing coil CLS1 and the first magnetic element MEG1 is obtained, the position of the optical element holder 108 having the first magnetic element MEG1 relative to the base 112 can also be obtained.

In addition, as shown in FIG. 2, the circuit board 114 is disposed on the base 112, and the plate coil 115 is disposed on the circuit board 114. In this embodiment, the circuit board 114 can be a flexible printed circuit (FPC), and the plate coil 115 can include four coils 115L respectively corresponding to the second magnetic elements MEG2. In addition, as shown in FIG. 2, the optical system 100 further includes two second resilient elements 116A and two second resilient elements 116B. Each of the second resilient elements has a long strip-shaped structure, such as a column-shaped structure or a line-shaped structure, but the shape is not limited thereto. In this embodiment, one end of the second resilient element is connected to the upper spring sheet 106, and the other end of the second resilient element is connected to the circuit board 114. Based on the structural configuration, the optical element holder 108 with the optical element (not shown in the figures) and the frame 104 can move relative to the base 112 along the X-Y plane through the second resilient elements 116A and the second resilient elements 116B.

In this embodiment, the plate coil 115 is directly in contact with and electrically connected to the circuit board 114. For example, there are some electrical contacts on the plate coil 115 for contacting the conductive lines of the circuit board 114. When the coils in the plate coil 115 are supplied with electricity, the coils act with the corresponding second magnetic elements MEG2 to generate the electromagnetic force, so as to drive the optical element holder 108, the optical element and the frame 104 to move along the X-Y plane. As a result, when the optical system 100 is shaken, the optical element holder 108 can be driven by the electromagnetic force to move along the X-Y plane, so as to compensate for the movement of the optical system 100 that is a result of the shaking, and the purpose of optical image stabilization (OIS) can be achieved.

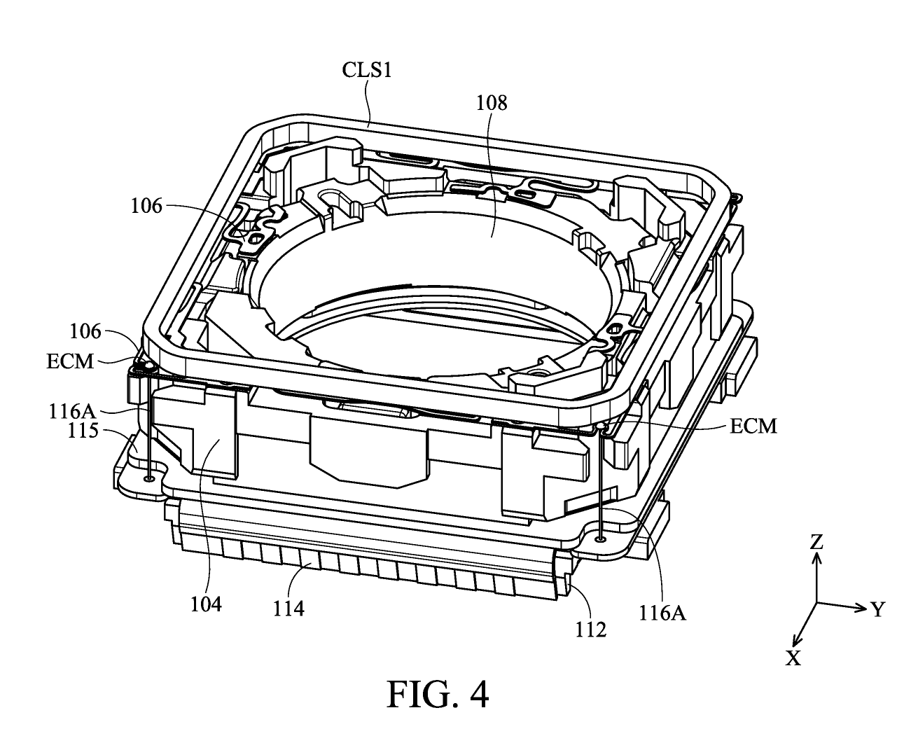

Please refer to FIG. 2 and FIG. 4. FIG. 4 shows a schematic diagram of the optical system 100 after removing the casing 102 according to the embodiment of the disclosure. As shown in FIG. 4, an input terminal and an output terminal of the sensing coil CLS1 can be directly connected to the upper spring sheet 106 through two electrical connecting elements ECM (such as solder), and then two corresponding second resilient elements 116A are also respectively connected to the electrical connecting elements ECM and the circuit board 114. That is, the sensing coil CLS1 can be electrically connected to the circuit board 114 through the second resilient elements 116A. Similarly, an input terminal and an output terminal of the first magnetic element MEG1 can also be electrically connected to the circuit board 114 through the upper spring sheet 106 and the two second resilient elements 116B. It is noted that the second resilient elements 116B are not shown in FIG. 4 due to the angle of view.

The optical system 100 of the present disclosure utilizes the sensing coil CLS1 to sense the magnetic field variation in the first magnetic element MEG1 to obtain the position of the optical element holder 108 relative to the base 112, so that only four second resilient elements are needed to transmit the electronic signals from the sensing coil CLS1 and the first magnetic element MEG1 to the circuit board 114. Because there is no position-sensing element disposed in the optical system 100, the optical system 100 does not need to provide additional conductive lines for a position-sensing element (such as a Hall sensor) to transmit the electronic signal. Therefore, the complexity of the layout of conductive lines of the optical system 100 can be reduced, and the manufacturing cost can also be reduced. Furthermore, the size of the optical system 100 without the position-sensing element can also be reduced, so as to achieve the purpose of miniaturization.

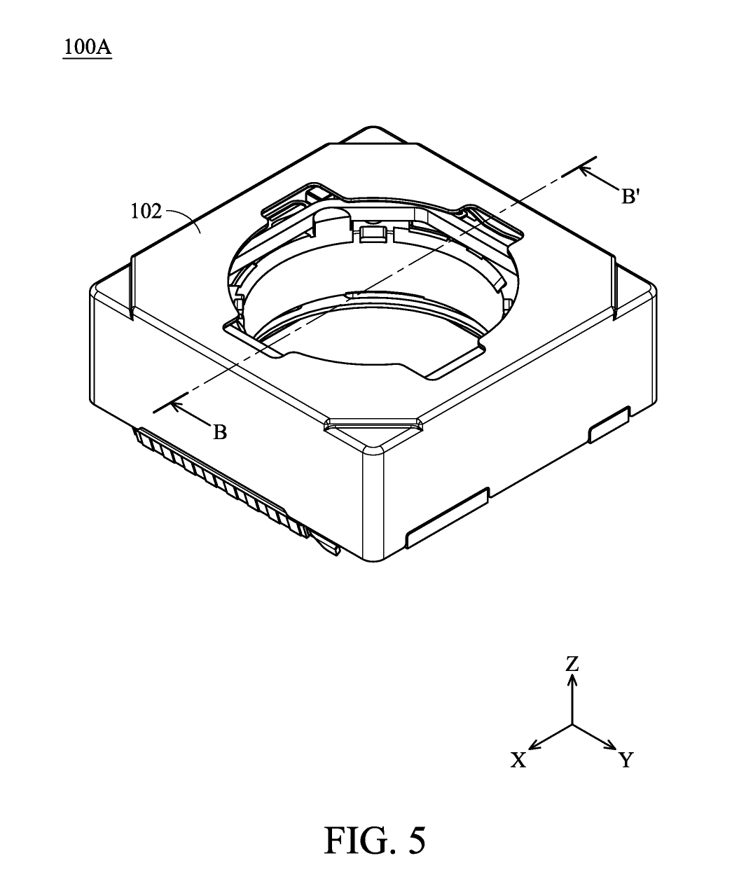

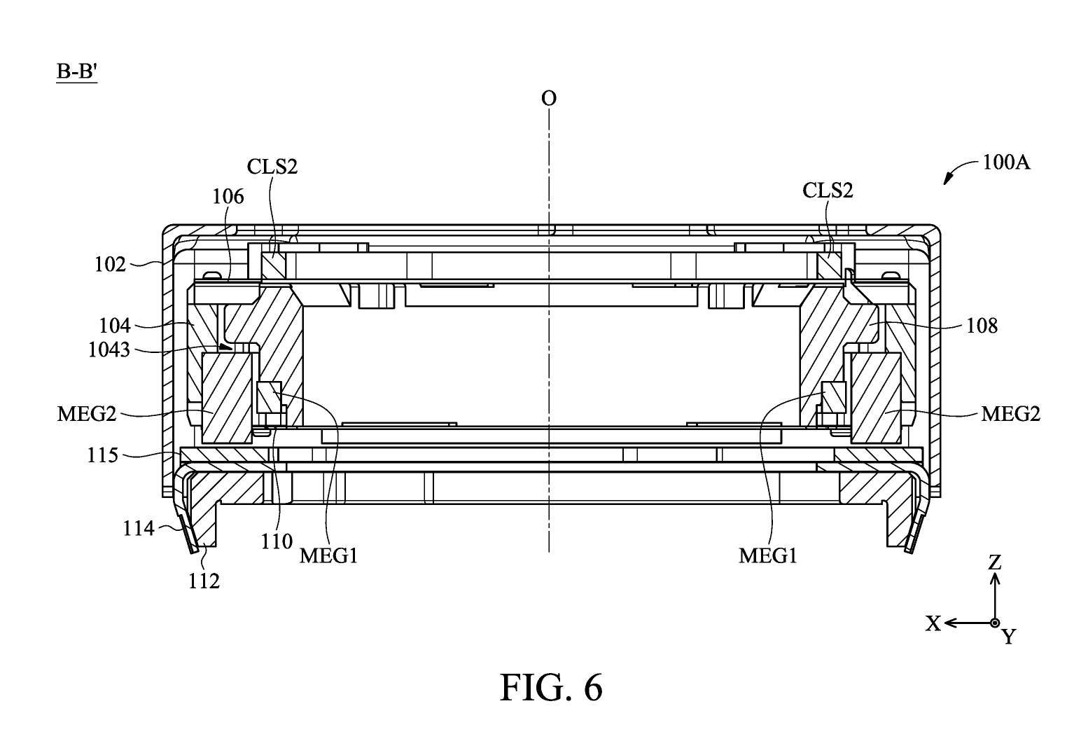

Please refer to FIG. 5 and FIG. 6. FIG. 5 shows a schematic diagram of an optical system 100A according to another embodiment of the disclosure, and FIG. 6 shows a cross-sectional view of the optical system 100A along line B-B′ in FIG. 5 according to the embodiment of the disclosure. The optical system 100A in this embodiment is similar to the optical system 100 in the previous embodiment, and the difference between the optical system 100 and the optical system 100A is that the first magnetic element MEG1 (coil) is disposed on the bottom portion of the optical element holder 108, and a sensing coil CLS2 is disposed on the top portion of the optical element holder 108, as shown in FIG. 6. In this embodiment, the winding axis of the sensing coil CLS2 can be substantially parallel to the winding axis of the first magnetic element MEG1, and the sensing coil CLS2 partially overlaps the first magnetic element MEG1 when viewed along the optical axis O. That is, the number of turns of the sensing coil CLS2 and the first magnetic element MEG1 can be the same or different.

When the first magnetic element MEG1 is supplied with electricity and acts with the four second magnetic elements MEG2 to generate the electromagnetic force to drive the optical element holder 108 to move along the optical axis O (the Z-axis direction) relative to the frame 104, the distance between the sensing coil CLS2 and the second magnetic elements MEG2 along the Z-axis direction changes, so that the magnetic field of the sensing coil CLS2 varies based on Lenz law and accordingly generates a sensing current. The sensing current can be outputted to the processing unit, and then the processing unit can determine the position of the optical element holder 108 relative to the base 112 according to the received sensing current and another reference information. In this embodiment, the reference information can include a relationship table between the sensing current and the position of the optical element holder 108 relative to the base 112.

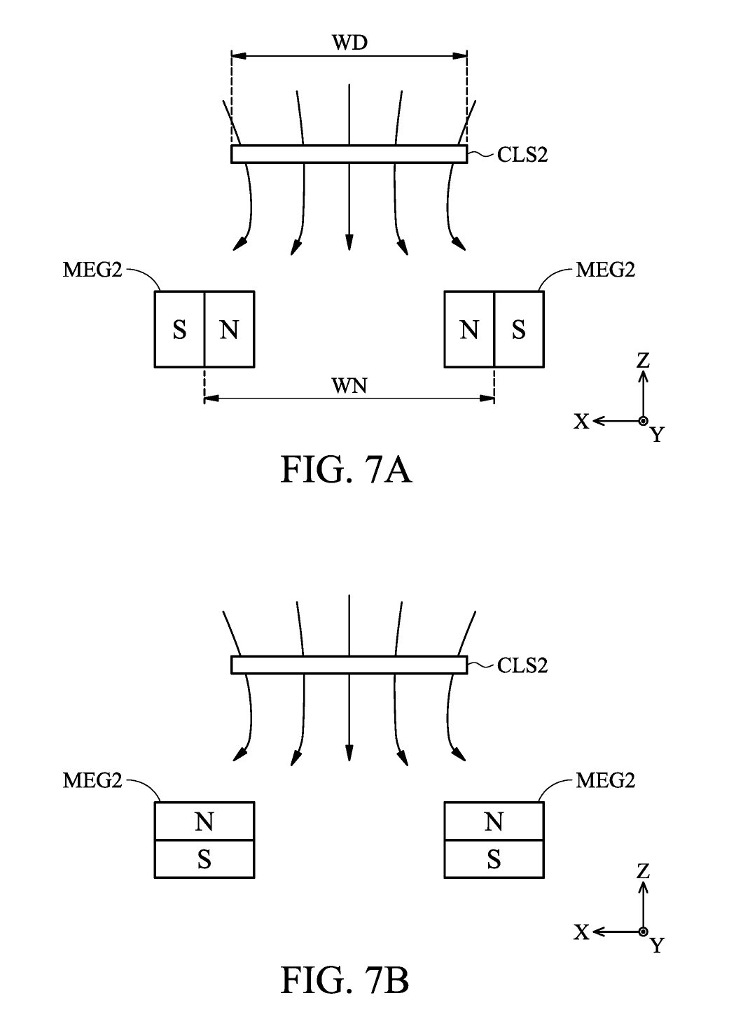

In addition, please refer to FIG. 7A and FIG. 7B. FIG. 7A shows a diagram of the sensing coil CLS2 and the second magnetic elements MEG2 in FIG. 6 according to the embodiment of the disclosure. FIG. 7B shows a diagram of the sensing coil CLS2 and the second magnetic elements MEG2 according to another embodiment of the disclosure. As shown in FIG. 7A, the sensing coil CLS2 moves along the Z-axis direction relative to the second magnetic elements MEG2, and the magnetic pole direction of the second magnetic elements MEG2 is substantially perpendicular to the Z-axis. It should be noted that the width WD of the sensing coil CLS2 along the X-axis direction is less than the maximum distance WN between the N-poles of the two second magnetic elements MEG2.

In addition, as shown in FIG. 7B, the magnetic pole direction of the second magnetic elements MEG2 is substantially parallel to the Z-axis direction. For example, the two second magnetic elements MEG2 are disposed to face the sensing coil CLS2. Therefore, the sensing ability of the sensing coil CLS2 can be enhanced based on this configuration.

Similar to the previous embodiments, there is no position-sensing element disposed in the optical system 100A in this embodiment. As a result, the optical system 100A does not need to provide additional conductive lines, and the sensing coil CLS2 and the first magnetic element MEG1 can be electrically connected to the circuit board 114 respectively through the second resilient elements 116A and the second resilient elements 116B. Therefore, the complexity of the layout of conductive lines of the optical system 100A can be reduced, and the manufacturing cost can also be reduced. Similarly, the size of the optical system 100A without the position-sensing element can also be reduced, so as to achieve the purpose of miniaturization.

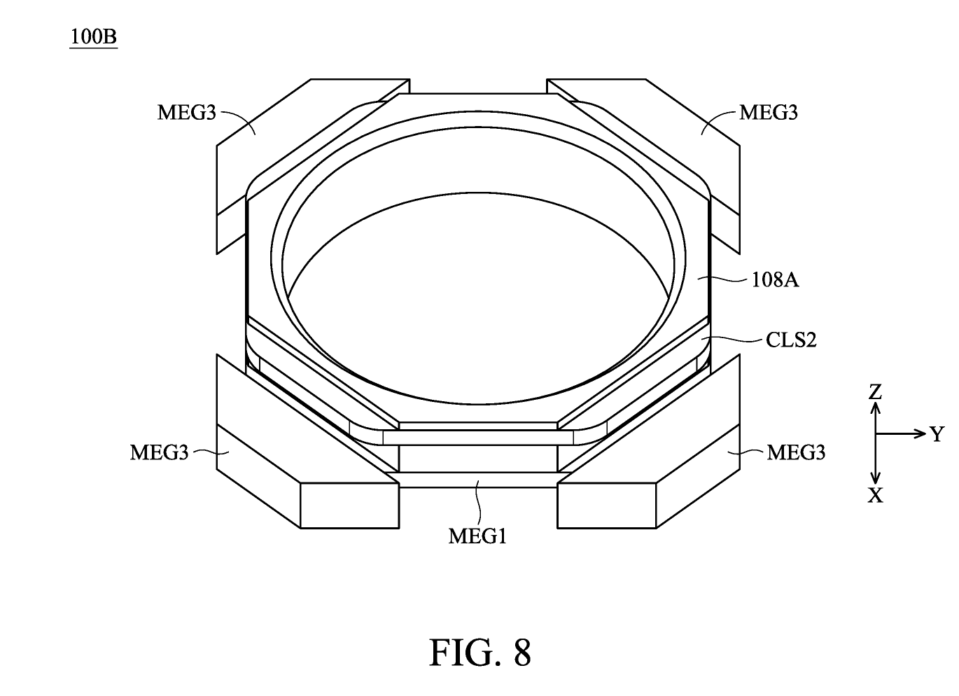

Please refer to FIG. 8, which shows a schematic diagram of an optical system 100B according to another embodiment of the disclosure. For convenience of description, only the driving assembly, an optical element holder 108A and the sensing coil CLS2 of the optical system 100B are illustrated in FIG. 8. In this embodiment, the optical element holder 108A has an octagonal structure, and each of four second magnetic elements MEG3 has a trapezoidal structure. The four second magnetic elements MEG3 are respectively disposed on four corners of the optical element holder 108A, so as to act with the first magnetic element MEG1 to generate the electromagnetic force.

The driving mechanism of this embodiment is similar to the previous embodiment, so that it is omitted herein. It should be noted that the size of the optical system 100B along the X-axis direction and the Y-axis direction can be further reduced because of the design of the shapes of the optical element holder 108A and the second magnetic elements MEG3, so as to further achieve the purpose of miniaturization.

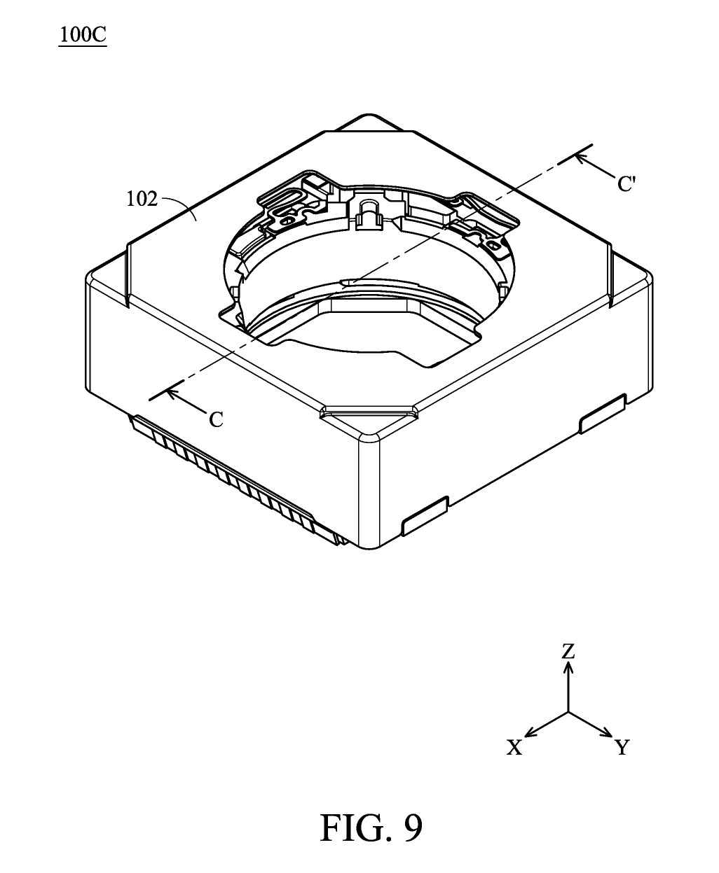

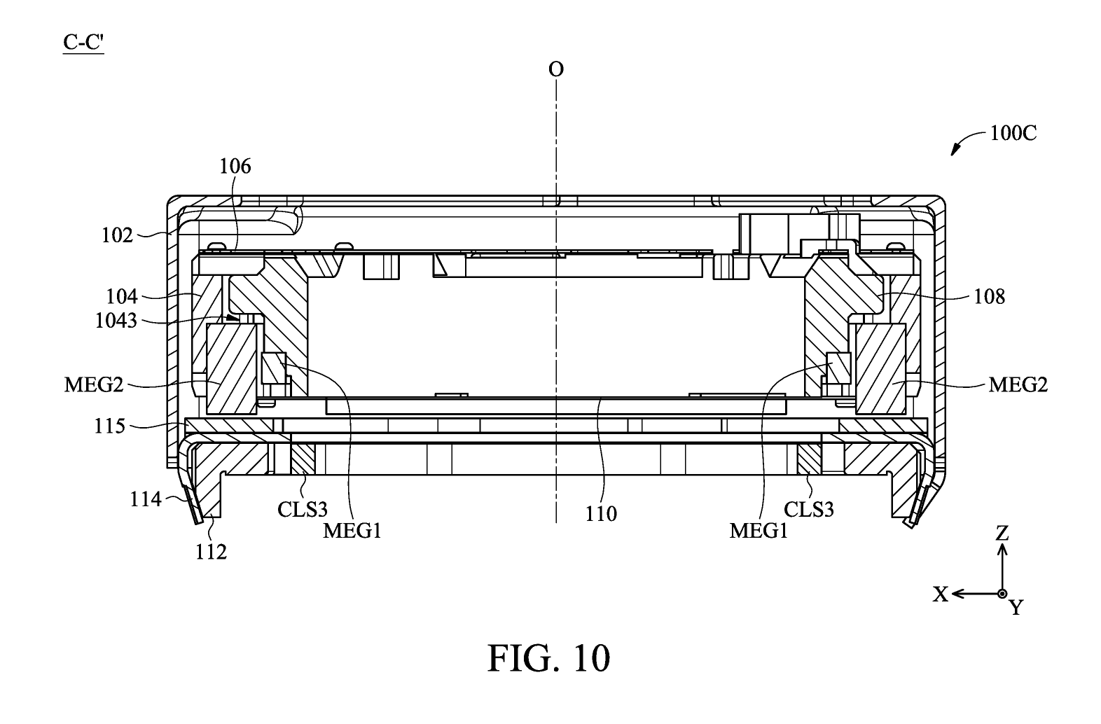

Please refer to FIG. 9 and FIG. 10. FIG. 9 shows a schematic diagram of an optical system 100C according to another embodiment of the disclosure. FIG. 10 shows a cross-sectional view of the optical system 100C along line C-C′ in FIG. 9 according to the embodiment of the disclosure. The optical system 100C in this embodiment is similar to the optical system 100 in the previous embodiment. The difference between the optical system 100C and the optical system 100 is that the first magnetic element MEG1 is disposed on the optical element holder 108, and a sensing coil CLS3 is disposed on the bottom of the circuit board 114 in this embodiment. In this embodiment, the circuit board 114 can be defined to be included in the fixed part. As shown in FIG. 10, the circuit board 114 is disposed on the base 112, and the sensing coil CLS3 is disposed on a bottom surface of the circuit board 114 along the Z-axis direction and is electrically connected to the circuit board 114. In addition, in other embodiments, the circuit board 114 can be disposed on the base 112, the sensing coil CLS3 can be disposed on the circuit board 114, and the circuit board 114 is located between the sensing coil CLS3 and the base 112.

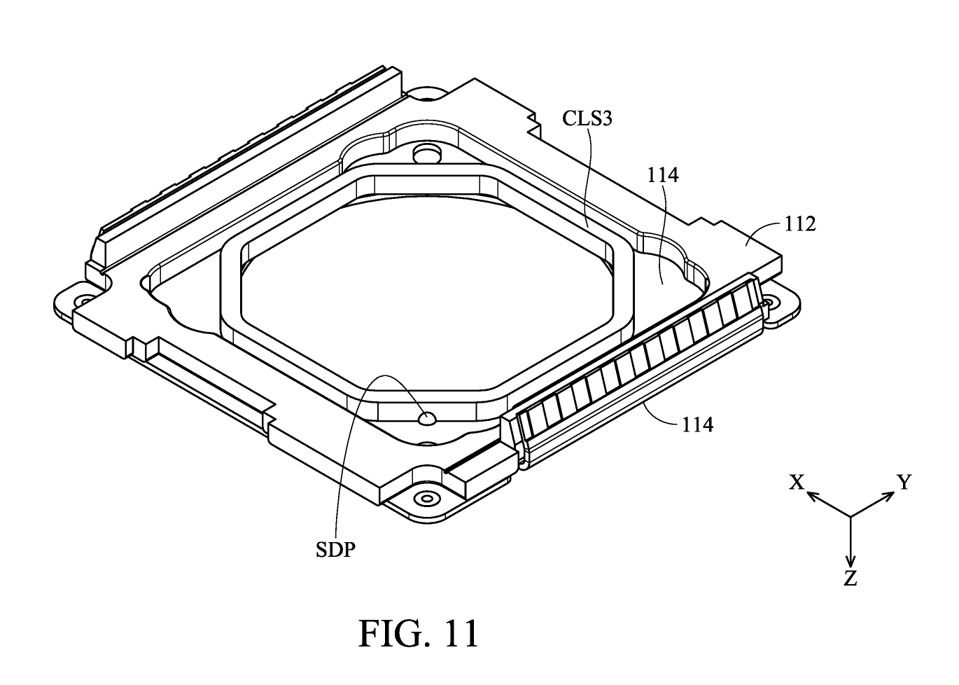

Next, please refer to FIG. 11, which shows a diagram illustrating the base 112, the circuit board 114 and the sensing coil CLS3 of the optical system 100C in FIG. 9 when viewed in another view of angle. As shown in FIG. 11, the sensing coil CLS3 is disposed on the bottom surface of the circuit board 114, and the sensing coil CLS3 is electrically connected to the circuit board 114 through a solder point SDP. Because the sensing coil CLS3 in this embodiment can be electrically connected to the circuit board 114 without the second resilient elements 116A, the interference can be reduced when the signal is transmitted between the sensing coil CLS3 and the circuit board 114, so as to prevent the problem of noise.

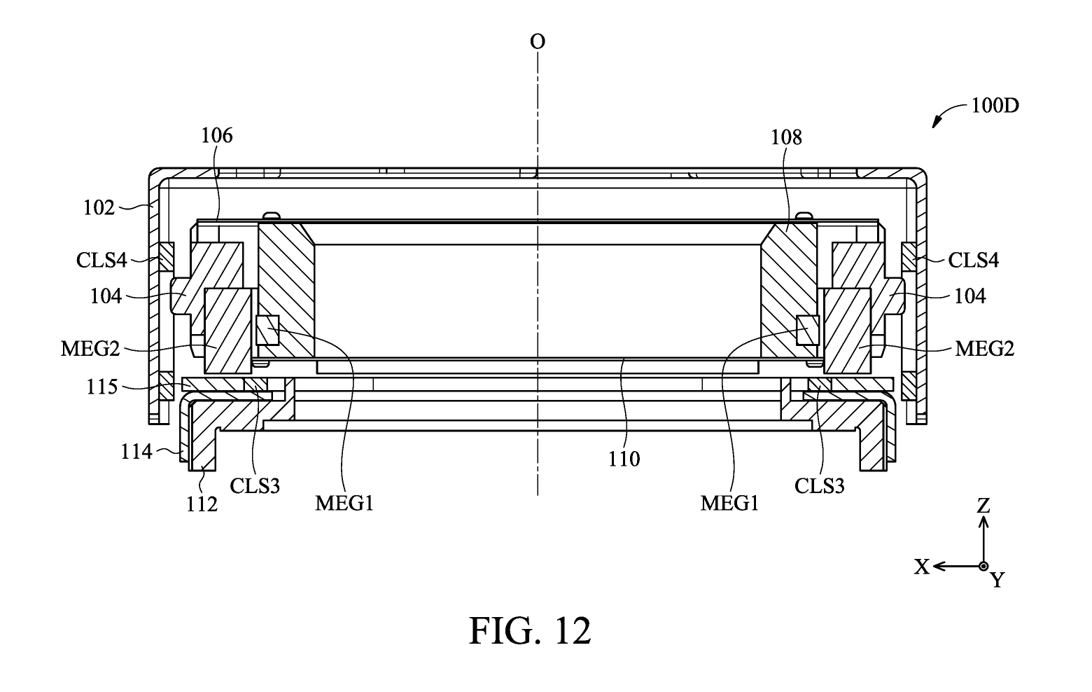

Please refer to FIG. 12, which shows a cross-sectional view of an optical system 100D according to another embodiment of the disclosure. The optical system 100D in this embodiment is similar to the optical system 100C, and the difference between the optical system 100D and the optical system 100C is that the sensing coil CLS3 is disposed between the circuit board 114 and the base 112, and the optical system 100D further includes four sensing coils CLS4. In this embodiment, the sensing coils CLS4 are connected to the casing 102. For example, the sensing coils CLS4 can be securely disposed on the inner surfaces of four sides of the casing 102, and the sensing coils CLS4 face the corresponding second magnetic elements MEG2. In this embodiment, the winding axis of the sensing coils CLS4 is not parallel to the optical axis O. Furthermore, it should be noted that the positions of the sensing coils CLS4 are not limited to this embodiment. For example, the fixed part can further include another frame (not shown in the figures), which is disposed between the casing 102 and the frame 104 and is securely connected to the base 112. The sensing coils CLS4 can be disposed on said frame.

When the optical system 100D is shaken, the optical element holder 108 and the frame 104 move along the XY plane. For example, when the frame 104 in FIG. 12 moves close to or away from the sensing coils CLS4 along the X-axis direction, the magnetic field of the sensing coils CLS4 varies based on Lenz law and accordingly generates a sensing current. Then, the processing unit can determine the position of the optical element holder 108 along the XY plane relative to the base 112 according to the received sensing current and another reference information. The reference information in this embodiment can include a relationship table between the sensing current and the position of the optical element holder 108 along the XY plane relative to the base 112.

Because there is no position-sensing element disposed in the optical system 100D in this embodiment, the optical system 100D can also achieve the purpose of miniaturization. In addition, the sensing coils CLS4 can also be a plate coil, so as to further achieve the purpose of miniaturization. In this embodiment, the optical system 100D does not need any position-sensing element, and the displacement of the optical element holder 108 along the XY plane relative to the base 112 can be obtained through the four sensing coils CLS4.

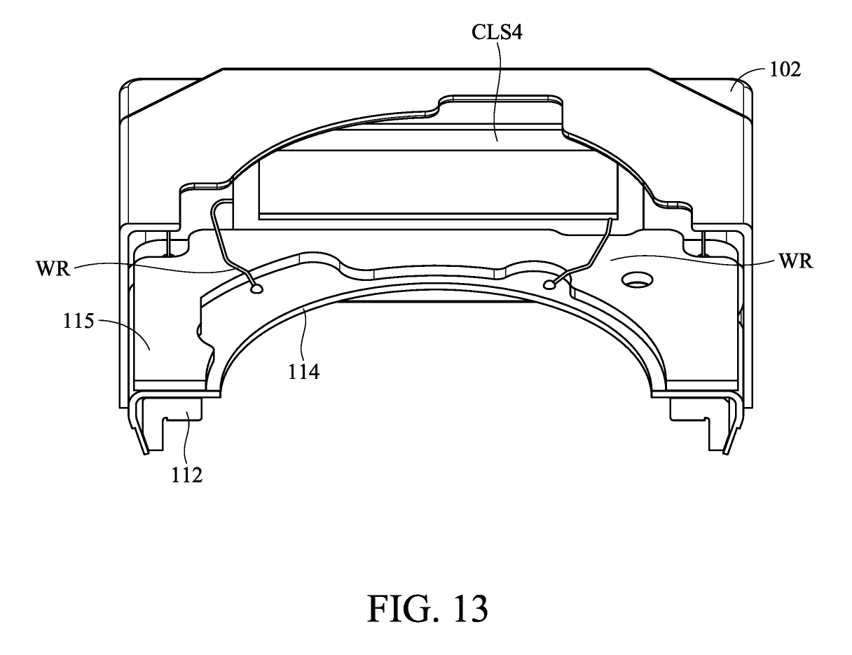

In addition, please refer to FIG. 13, which shows a partial structure of the optical system 100D according to the embodiment of the disclosure. As shown in FIG. 13, the sensing coil CLS4 is connected to the circuit board 114 through wires WR. Because there is no movement between the casing 102 and the circuit board 114, the problem of the wires WR between the sensing coils CLS4 and the circuit board 114 being easily damaged can be prevented.

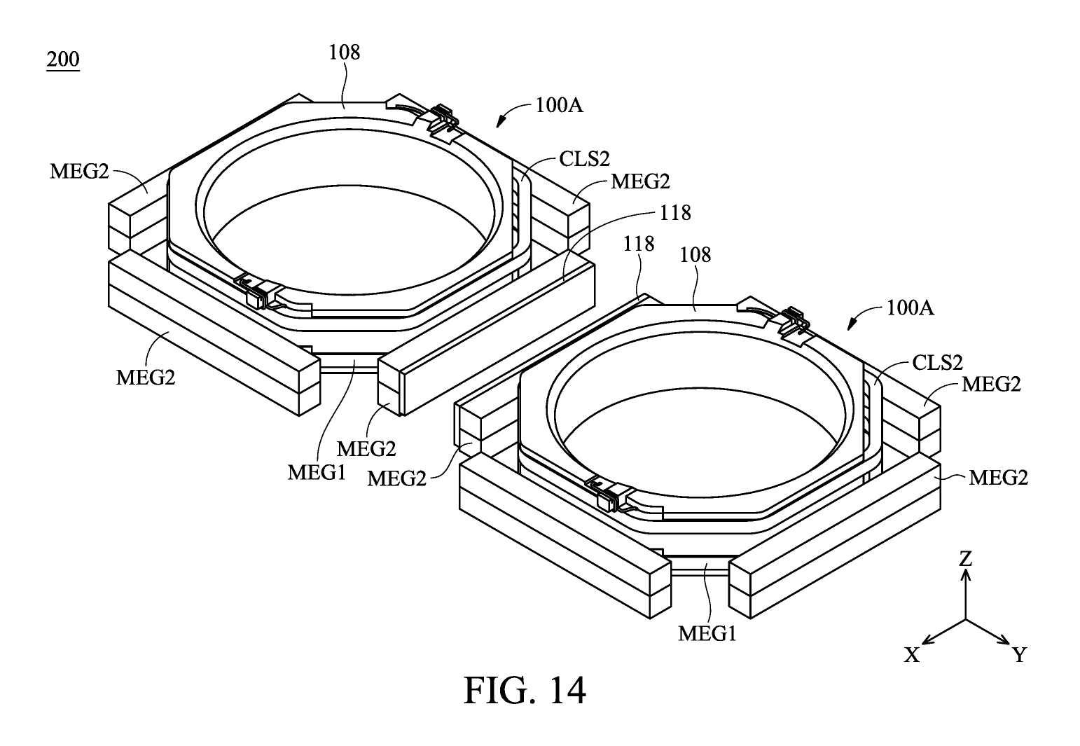

Please refer to FIG. 14, which shows a camera system 200 according to another embodiment of the disclosure. In this embodiment, the camera system 200 can include two optical systems 100A, and the two optical systems 100A are disposed near each other. Only some of the elements of the optical systems 100 are illustrated in FIG. 14 for clarity. As shown in FIG. 14, the optical system 100A in this embodiment can further include a magnetic conductive element 118 (a magnetic conductive plate), disposed between the two second magnetic elements MEG2 facing each other. The magnetic interference between the two adjacent optical systems 100 can be reduced because of the magnetic conductive element 118.

In addition, there is no sensing magnet for a position-sensing element or a position sensor in the optical system 100A, so that not only can the overall size of the camera system 200 be reduced, but also the magnetic interference between the two adjacent optical systems 100 in the camera system 200 can be effectively reduced.

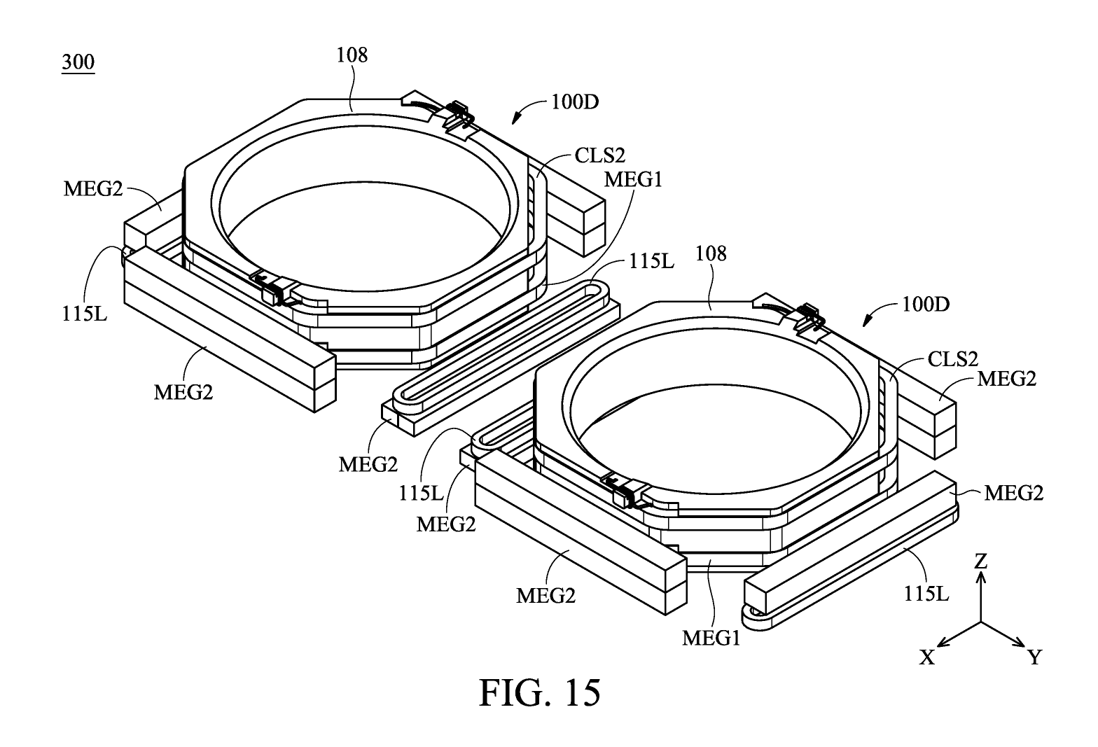

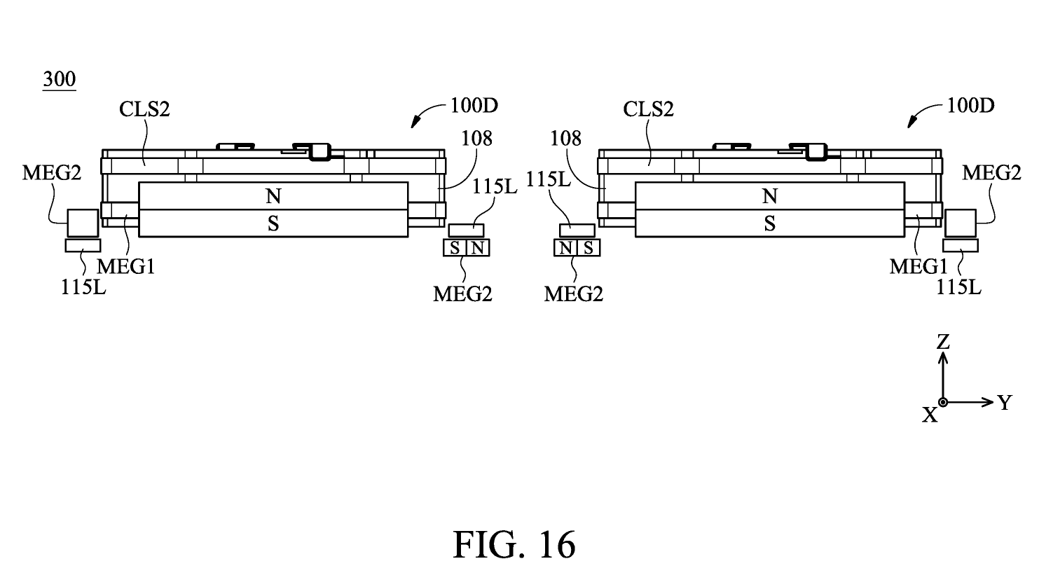

Please refer to FIG. 15 and FIG. 16. FIG. 15 shows a camera system 300 according to another embodiment of the disclosure. FIG. 16 shows a front view of the camera system 300 in FIG. 15 according to the embodiment of the disclosure. In this embodiment, the camera system 300 can include two optical systems 100D, and the two optical systems 100D are disposed near each other. The optical system 100D is similar to the optical system 100A, and the difference between the optical system 100D and the optical system 100A is that, in this embodiment, the coils 115L located between the two optical element holders 108 are disposed on the movable part (the movable part is not shown, and for example the movable part can be the frame 104 in FIG. 6), and the second magnetic elements MEG2 located between the two optical element holders 108 are securely disposed on the fixed part (the fixed part is not shown, and for example the fixed part can be the base 112 in FIG. 6).

It should be noted that the magnetic pole direction of the second magnetic elements MEG2 located between the two optical element holders 108 is substantially perpendicular to the Z-axis direction. As shown in FIG. 16, the North poles of the two second magnetic elements MEG2 face each other. Based on the structural design, magnetic interference can be reduced, and the distance between the two optical systems 100D can be decreased further, so as to achieve the purpose of miniaturization

In conclusion, the present disclosure provides an optical system which adopts a sensing coil configured to sense the displacement of the optical element holder relative to the base. Because there is no position-sensing element or corresponding sensing magnet occupying the interior space inside the optical system, the overall size of the optical system can be reduced to achieve the purpose of miniaturization, and the magnetic interference that is the result of a position-sensing element and the corresponding sensing magnet can also be prevented.

In addition, there is no position-sensing element disposed in the optical system, so the optical system does not need to provide additional conductive lines for the position-sensing element. The sensing coil and the first magnetic element of the present disclosure can be electrically connected to the circuit board through the second resilient elements. Therefore, the complexity of the layout of conductive lines of the optical system can be reduced, the manufacturing cost can be reduced, and the size of the optical system can also be reduced, so as to achieve the purpose of miniaturization.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical system, comprising:
a fixed part, comprising a base;
a movable part, comprising:
an optical element holder, configured to hold an optical element;
a driving assembly, comprising:
at least one first magnetic element; and
at least one second magnetic element, corresponding to the first magnetic element, and the second magnetic element being configured to drive the optical element holder to move relative to the base; and
a sensing coil, configured to sense a magnetic field variation in the first magnetic element, so as to obtain a distance between the optical element holder and the base.

2. The optical system as claimed in claim 1, wherein the first magnetic element comprises a coil, and a winding axis of the coil is substantially parallel to a winding axis of the sensing coil.

3. The optical system as claimed in claim 2, wherein the movable part further comprises a frame, the first magnetic element is disposed on the frame.

4. The optical system as claimed in claim 1, wherein the optical system further comprises a first resilient element, electrically connected to the sensing coil.

5. The optical system as claimed in claim 1, wherein the movable part further comprises a frame, the first magnetic element is disposed on the optical element holder, and the sensing coil is disposed on the frame.

6. The optical system as claimed in claim 5, wherein the optical system further comprises:
a first resilient element, connected to the optical element holder and the frame;
a circuit board; and
two second resilient elements, connected to the first resilient element and the circuit board, wherein the sensing coil is electrically connected to the circuit board through the two second resilient elements.

7. The optical system as claimed in claim 6, wherein the optical system further comprises two second resilient elements, connected to the first resilient element and the circuit board, wherein the driving assembly is electrically connected to the circuit board through the two second resilient elements.

8. The optical system as claimed in claim 1, wherein the first magnetic element is disposed on the optical element holder, and the sensing coil is disposed on the fixed part.

9. The optical system as claimed in claim 8, wherein the optical system further comprises a circuit board disposed on the base, and the sensing coil is disposed on the circuit board and is electrically connected to the circuit board, wherein the circuit board is located between the sensing coil and the base.

10. The optical system as claimed in claim 8, wherein the optical system further comprises a circuit board disposed on the base, and the sensing coil is electrically connected to the circuit board.

11. The optical system as claimed in claim 10, wherein the sensing coil is disposed on a bottom surface of the circuit board, and the sensing coil is electrically connected to the circuit board through a solder point.

12. The optical system as claimed in claim 1, wherein the sensing coil and the first magnetic element are disposed on the optical element holder, and a winding axis of the first magnetic element is substantially parallel to a winding axis of the sensing coil.

13. The optical system as claimed in claim 12, wherein the sensing coil partially overlaps the first magnetic element when viewed along an optical axis of the optical element.

14. The optical system as claimed in claim 12, wherein the magnetic pole direction of the second magnetic element is substantially parallel to an optical axis of the optical element.

15. The optical system as claimed in claim 12, wherein the magnetic pole direction of the second magnetic element is substantially perpendicular to an optical axis of the optical element.

16. The optical system as claimed in claim 15, wherein the optical system comprises two second magnetic elements, and a width of the sensing coil is less than a maximum distance between the N-poles of the two second magnetic elements.

17. The optical system as claimed in claim 1, wherein the fixed part further comprises a casing, and the sensing coil is connected to the casing.

18. The optical system as claimed in claim 17, wherein a winding axis of the sensing coil is not parallel to an optical axis of the optical element.

19. The optical system as claimed in claim 1, wherein the driving assembly further comprises a magnetic conductive element which is disposed near the second magnetic element.

20. The optical system as claimed in claim 1, wherein the optical system comprises four second magnetic elements, the optical element holder has an octagonal structure, and each of the second magnetic elements has a trapezoidal structure, wherein the second magnetic elements are respectively disposed on four corners of the optical element holder.
